(19) United States
(12) Patent Application Publication
(10) Pub. No.: US 2026/0288734 A1
(43) Pub. Date: Sep. 24, 2026

(54) SYSTEM AND METHOD OF AN INTELLIGENT RESEARCH ENGINE

(71) Applicant: Piedmont Innovations, LLC, Peachtree City, GA (US)

(72) Inventors: Paul Alexander Rudd, Peachtree City, GA (US); Marie Hazel George, Brooks, GA (US)

(21) Appl. No.: 19/375,730

(22) Filed: Oct. 31, 2025

Related U.S. Application Data
(60) Provisional application No. 63/714,266, filed on Oct. 31, 2024.

(51) Int. Cl. G06F 16/2457; G06F 16/242; G06N 20/00

(52) U.S. Cl. CPC G06F 16/24578; G06F 16/2423; G06N 20/00

(57) ABSTRACT

Disclosed herein is a data processing engine that leverages a curated training dataset in combination with supplemental external data sources. This integration enables the system to operate asynchronously, generating predictive outputs tailored to user-specific parameters, even in the absence of active user engagement.

### CROSS-REFERENCE TO RELATED APPLICATIONS

This application claims priority to and the benefit of U.S. Provisional Application No. 63/714,266, filed on Oct. 31, 2024, the content of which is incorporated by reference herein in its entirety.

### BACKGROUND

Advances in artificial intelligence (AI) have provided a launch point for intelligent human computer inactions. In the field of consulting, it has both expanded the amount of raw data beyond the human scale and provided tools to analyze and gather the growing catalogues of accessible data. However, AI has not replaced the skilled work of consultants to integrate, synthesize, interpret, and plan a course of action. Further still, the work of continually monitoring and updating a course of action over time is not conventionally done in an automated way.

### SUMMARY

Described herein is an intelligent research engine comprising a machine learning model, a large language model, and relevant business information. The business information can be structured or unstructured and may comprise elements such as patents, news articles, scientific literature, press releases, financial disclosures (e.g., 10k reports), product literature, clinical trials, or analyst reports. The engine uses curated data and provides a set of customized outputs, for example, based on the user persona and problem statement.

In some aspects, a method is disclosed; the method including: receiving a user prompt; querying a database; retrieving structural and/or relational latent data from the database based on the user prompt, wherein the structural and/or relational latent data is relevant to the user prompt; providing relevant structural and/or relational latent data to a machine learning model, wherein the machine learning model outputs one or more user recommendations related to the user prompt; and displaying the one or more user recommendations.

In some implementations, a computer-implemented method is provided. The method can include: populating a database based on a user objective; receiving a user prompt; querying the database based on the user prompt; retrieving structural and relational latent data from the database based on the user prompt, wherein the structural and relational latent data is relevant to the user prompt; providing relevant structural and relational latent data to a machine learning model, wherein the machine learning model outputs one or more latent user recommendations related to the user prompt; converting, using a large language model, the one or more latent user recommendations to one or more human-readable user recommendations; and displaying the one or more human-readable user recommendations.

In some implementations, populating the database includes: performing a search using the user objective; retrieving relevant data; labeling, by an expert, the relevant data with structural and relational labels; providing the labeled relevant data to the machine learning model; training the machine learning model using the labeled relevant data; and populating the database with structured data and weights of the machine learning model.

In some implementations, updating the database includes: retrieving, at periodic intervals, relevant data, wherein the periodic intervals are initiated by a timer function; labeling the unlabeled relevant data using a classifier; providing the labeled relevant data to the machine learning model; updating the weights of the machine learning model using the labeled relevant data; and updating the database with structured data and updated weights of the machine learning model.

In some implementations, the classifier is one of linear regression, Naïve Bayes', or a k-NN.

In some implementations, the timer function is a web-based resource, wherein the web-based resource includes a web-based application, a web-based database server, or combinations thereof.

In some implementations, updating the database is initiated by a change in status alert, wherein a change in status relates to a status change in the database and/or machine learning model retraining.

In some implementations, the change in status alert is related to a trigger function that includes a threshold variable.

In some implementations, the machine learning model includes a neural network, a convolutional neural network, a graph neural network, or a random forest.

In some implementations, the database includes structural and relational data and MLM weights.

In some implementations, the one or more human-readable user recommendations includes one or more of: one or more relevant facts from the database, a relational statement from the one or more relevant facts to the user prompt, a user recommendation for next steps, and/or combinations thereof.

In some implementations, the user objective is associated with a field of business, a market segment, technology commercialization, and/or related commercial entities.

In some implementations, the user prompt is a text string.

In some implementations, the computer-implemented method further includes: providing the user prompt to a large language model, wherein the large language model outputs a latent user prompt.

In some implementations, the computer-implemented method further includes: using a cognitive search function to deconstruct the latent user prompt into a database query.

In some implementations, the user prompt is associated with a finite question related to the user objective.

In some implementations, a system is provided. The system can include a processor, and a memory storing instructions thereon, wherein execution of the instructions causes the processor to: populate a database based on a user objective; receive a user prompt; query the database based on the user prompt; retrieve structural and relational latent data from the database based on the user prompt, wherein the structural and relational latent data is relevant to the user prompt; provide relevant structural and relational latent data to a machine learning model, wherein the machine learning model outputs one or more latent user recommendations related to the user prompt; convert, using a large language model, the one or more latent recommendations to one or more human-readable user recommendations; and display the one or more human-readable user recommendations.

In some implementations, execution of the instructions causes the processor to populate the database based on a user objective by: performing a search using the user objective; retrieving relevant data; labeling, by an expert, the relevant data with structural and relational labels; providing the labeled relevant data to the machine learning model; training the machine learning model using the labeled relevant data; and populating the database with structured data and weights of the machine learning model.

In some implementations, execution of the instructions causes the processor to update the database by: retrieving, at periodic intervals, relevant data, wherein the periodic intervals are initiated by a timer function; labeling the unlabeled relevant data using a classifier; providing the labeled relevant data to the machine learning model; updating the weights of the machine learning model using the labeled relevant data; and updating the database with structured data and updated weights of the machine learning model.

In some implementations, execution of the instructions causes the processor to further update the database by: retrieving, at periodic intervals, relevant data, wherein the periodic intervals are initiated by a timer function; labeling the unlabeled relevant data using a classifier; providing the labeled relevant data to the machine learning model; updating the weights of the machine learning model using the labeled relevant data; and updating the database with structured data and updated weights of the machine learning model.

In some implementations, the classifier is one of linear regression, Naïve Bayes', or a k-NN.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a block diagram of the system including an intelligent research engine according to some implementations.

FIG. 2 is a block diagram of an example method according to some implementations.

FIG. 3 is a block diagram of an example method according to some implementations.

FIG. 4 is a block diagram of an example method according to some implementations.

FIG. 5 is a block diagram of an example method according to some implementations.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, a system and method of an intelligent research engine is shown, according to various implementations. The intelligent research engine being configured to provide recommendations related to a user prompt. A user prompt may be related to a business question including, but not limited to, markets such as financial, commodities, products, or services, trends of said markets, projections of said markets, a nexus of two or more markets or market segments, or any other question which may otherwise be posited to a business consultant.

Embodiments of the present disclosure relate to a consulting engine comprising a machine learning model, a large language model, and relevant business information. The business information can be structured or unstructured and may comprise elements such as patents, news articles, scientific literature, press releases, financial disclosures (e.g., 10k reports), product literature, clinical trials, or analyst reports. The consulting engine can generate and use curated data and provides a set of customized recommendations based on the user persona and problem statement. In some implementations, the consulting engine stores the user's problem statement and provides periodic updates with recommendations.

Conventional implementations of large language models (LLMs) in consulting applications are typically limited to synchronous, user-initiated interactions and rely heavily on generalized datasets. Additionally, conventional systems are not capable of automatically updating or curating the underlying data being used in a manner that is relevant for specific users. These systems often lack the contextual depth and adaptability required for delivering personalized, actionable insights. The present disclosure addresses these limitations by introducing a technically advanced consulting engine that leverages a curated training dataset in combination with supplemental external data sources. This integration enables the system to operate asynchronously, generating context-aware recommendations even in the absence of active user engagement. Additionally, the engine enhances decision-making processes by providing personalized next-step guidance tailored to user-specific parameters, thereby improving both the relevance and efficiency of the recommendations.

Relational latent data refers to implicit relationships that are not directly observable within raw datasets but are instead derived through the identification of complex patterns. Extracting and utilizing such data typically requires advanced computational models, substantial volumes of training data, and precise model calibration to mitigate risks such as overfitting or erroneous interpretation. The inherent ambiguity and potential for inaccurate correlations present challenges in maintaining consistency and reliability in model outputs. Furthermore, the real-time capture and application of relational latent data is technically demanding and resource-intensive. The disclosed system and method address these limitations by efficiently leveraging relational latent data through the use of carefully curated datasets that incorporate user-specific parameters, thereby enhancing the precision and contextual relevance of generated outputs.

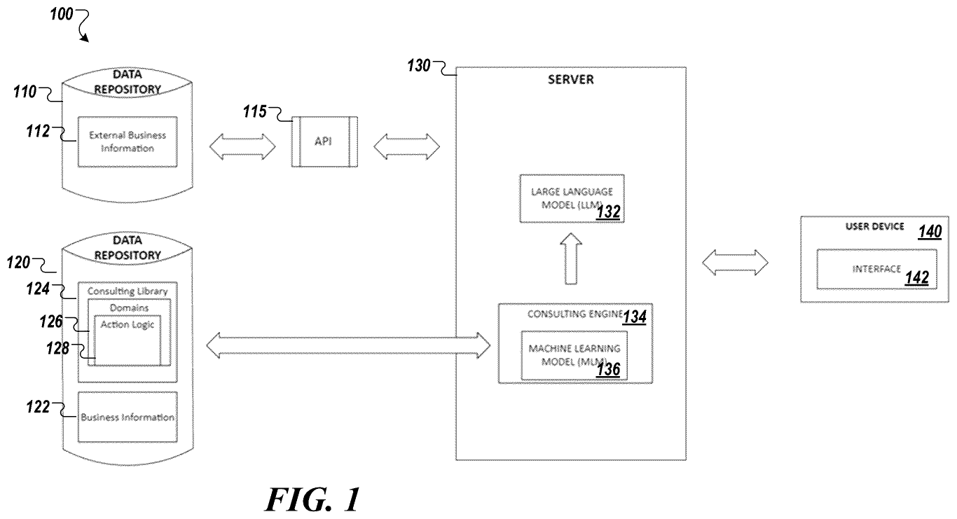

Referring to FIG. 1, the system 100 including an intelligent research engine 134 according to some implementations is shown. The system includes a user device 140 and a server 130, the server including a large language model 132 and a consulting engine 134 which further includes a machine learning model. In some implementations, the user device 140 includes an interface 142. In some implementations, the server 130 is included on the user device 140. In some implementations, the server includes two or more servers, wherein a first server includes the LLM 132 and a second server includes the consulting engine 134 and machine learning model 136. In this implementation, the first server is a remote server and the second server is housed on the user device 140. The system further includes a first data repository 110 including external business information 112 and a second data repository 120 including business information 122 and a consulting library 124. The consulting library 124 includes domains 126 and action logic 128. The first data repository 110 is accessed by the server 130 using an application programming interface (API) 115. In some implementations, the API 115 is included in the server through a communication interface or as part of the consulting engine 134. In other implementations, the API 115 is included on a remote server in communication with the server 130.

In some implementations, the consulting engine 134 populates the consulting library 124. In other implementations, a user populates the consulting library 124 and the business information 122. For example, the user populates the business information 122 in a first instance. In another example, a first set of data of the external business information 112 is labeled for, e.g., domains and action logic, by the user and added to the consulting library 124. In another example, the machine learning module 136 labels, e.g., domains and action logic, a second set of data of the external business information 112, such labeled second set of data is included in the consulting library 124.

In some implementations, the first data repository 110 includes a segment or a plurality of segments of the world wide web, a segment or a plurality of segments of open source data, or a segment or a plurality of segments of closed source data. In some implementations, the external business information 112 includes any business information of the first data repository 110. In some implementations, the external business information 112 is accessible directly from the API 115, and in other implementations, the API 115 submits a request to the first data repository 110 for the external business information 112. In other implementations, the API 115 submits a request to the first data repository 110 and receives a plethora of unstructured data (e.g. including more than business information). In an example implementation, the API 115 submits a request through a search engine of the world wide web, wherein the world wide web refers to the first data repository 110, and wherein the search engine results may include external business information 112.

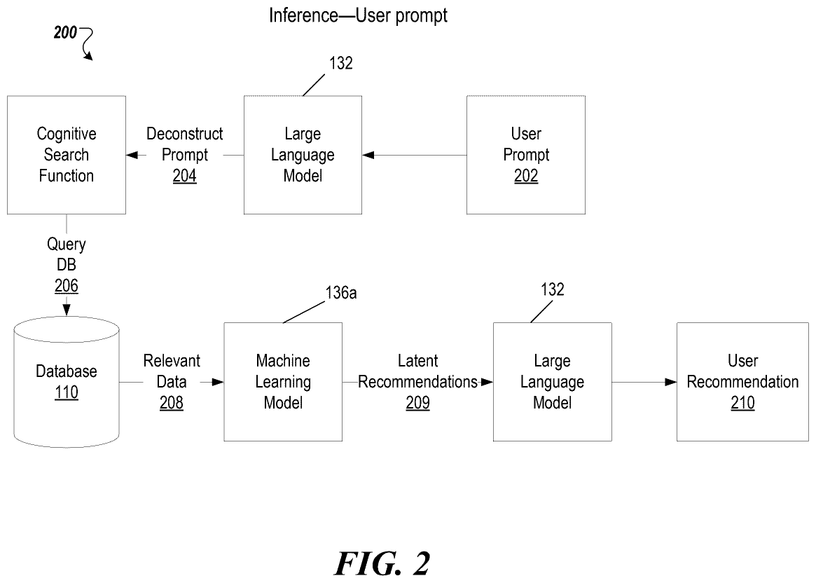

Referring now to FIG. 2, an implementation of an example method 200 is shown. The method includes receiving a user prompt 202, deconstructing the prompt 204, applying a cognitive search function, querying a database 206 comprising one or more of a consulting library and business information; retrieving structural and/or relational latent data 208 from a database 110 based on the user prompt, wherein the structural and/or relational latent data is relevant to the user prompt 202; providing the relevant structural and/or relational latent data 208 to a machine learning model 136a, wherein the machine learning model 136a outputs one or more latent recommendations 210 related to the user prompt; converting the one or more latent recommendations 209, using a large language model (LLM) 132, to one or more human-readable user recommendations 210; and outputting/displaying the one or more human-readable user recommendations 210.

In other implementations, the method includes receiving the user prompt, querying a database comprising one or more of a consulting library and business information; retrieving structural and/or relational data from the database based on the user prompt, wherein the structural and/or relational latent data is relevant to the user prompt; providing relevant structural and/or relational data to a machine learning model, wherein the machine learning model outputs one or more user recommendations related to the user prompt; and displaying the one or more user recommendations.

In yet other implementations, the method includes receiving a user prompt, providing the user prompt to an LLM, wherein the LLM outputs a latent user prompt; querying a database comprising one or more of a consulting library and business information; retrieving structural and/or relational latent data from the database based on the latent user prompt, wherein the structural and/or relational latent data is relevant to the user prompt; providing relevant structural and/or relational latent data to a machine learning model, wherein the machine learning model outputs one or more latent recommendations related to the user prompt; converting the one or more latent recommendations, using the LLM, to one or more human-readable user recommendations; and displaying the one or more human-readable user recommendations.

In some implementations, the user prompt may be a text string, a structured text data (e.g. table), one or more parameters including numerical, text, metadata, or logical parameters. It is contemplated that when the user prompt is a text string, the LLM is used to convert the text string into a latent user prompt. In some implementations, the method further includes using a cognitive search function to deconstruct the latent user prompt into a database query. In some examples, the cognitive search function is a module in the consulting engine 134 or in the API 115 of the system.

In some implementations, the user recommendation includes one or more of: one or more relevant facts from the database, a relational statement from the one or more relevant facts to the user prompt, a user recommendation for next steps, and/or combinations thereof.

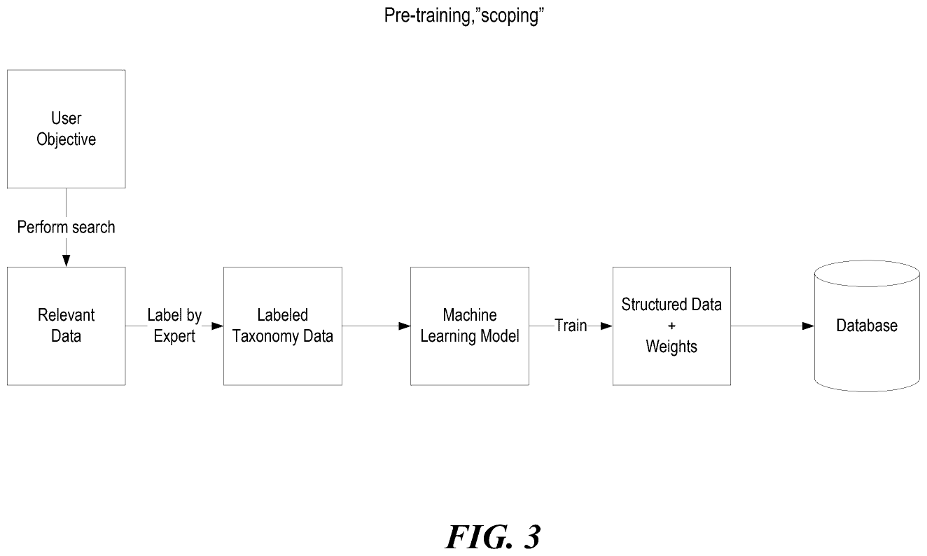

In some implementations, the method further includes populating the database comprising one or more of a consulting library and business information. As shown in FIG. 3, populating the database includes providing a user objective to the server or consulting engine; performing a search using the user objective; retrieving unlabeled relevant data from an external source (i.e., the first data repository 110 of the system); labeling, by an expert, the relevant data with structural and/or relational labels; providing the labeled relevant data to the machine learning model; training the machine learning model using the labeled relevant data; and populating the database with structured data and weights of the trained machine learning model.

In other implementations, populating the database further includes additionally populating the database with the labeled relevant data.

In some implementations, the user objective is envisioned to be related to and broader than the user prompt. For example, the user objective is associated with a field of business, a market segment, technology commercialization, and/or related commercial entities. In some implementations, the user prompt is associated with a finite question related to the user objective.

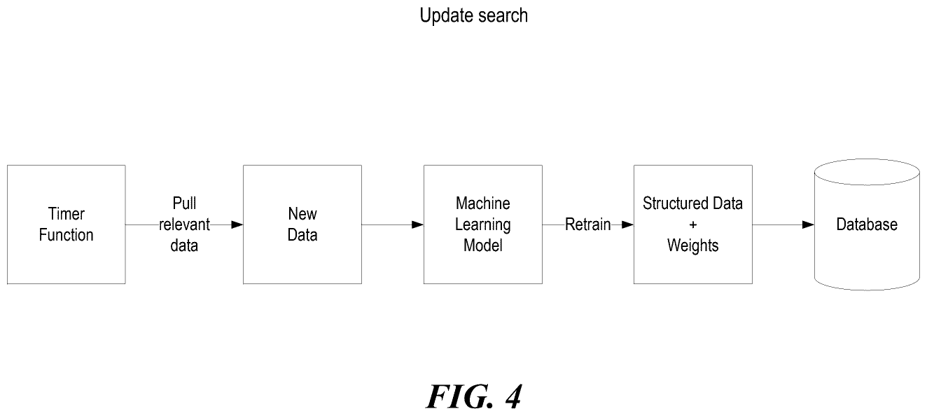

In some implementations, the method further includes updating the database. As shown in FIG. 4, updating the database includes retrieving, at periodic intervals, unlabeled relevant data, wherein a timer function prompts retrieval at periodic intervals; labeling the unlabeled relevant data using the machine learning model; reweighting the machine learning model using the unlabeled relevant data; and updating the database with structured data and weights of the machine learning model.

In some implementations, updating the database includes retrieving, at periodic intervals, unlabeled relevant data from the external source; labeling the unlabeled relevant data using a classifier; providing the labeled relevant data to the machine learning model; re-weighting the machine learning model using the unlabeled relevant data; and updating the database with structured data and weights of the machine learning model.

In some implementations, the classifier is one of linear regression, Naïve Bayes', k-NN, or any suitable classifier.

In some implementations, the periodic intervals are initiated by a timer function. In other implementations, the timer function is a web-based resource, wherein the web-based resource includes a web-based application, a web-based database server, or combinations thereof.

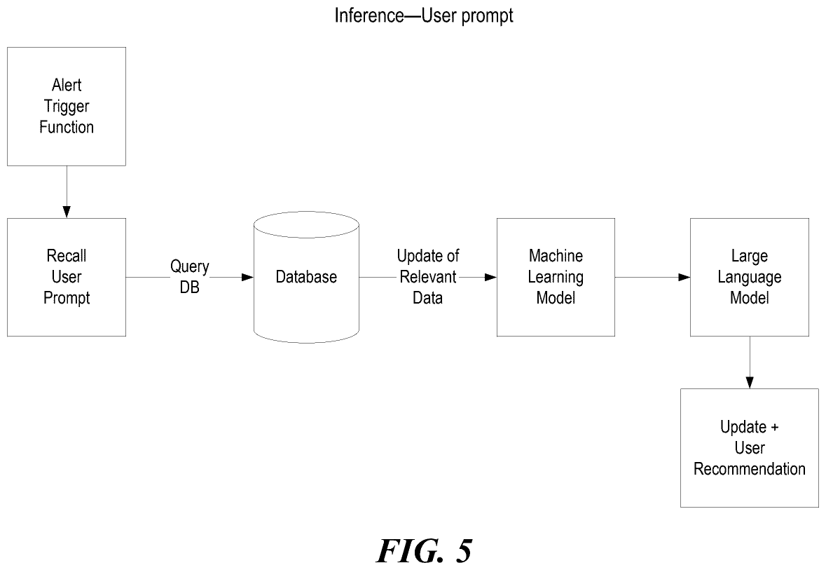

In some implementations, the method further includes updating the user recommendation. As shown in FIG. 5, updating the user recommendation includes recalling the user prompt, which can be initiated by an alert trigger function; querying the database; retrieving structural and/or relational latent data from the database based on the user prompt; providing relevant structural and/or relational latent data to the machine learning model, wherein the machine learning model outputs one or more latent recommendations related to the user prompt, wherein at least one of the one or more user recommendations is an updated or new user recommendation; converting the one or more latent recommendations using the LLM, to one or more human-readable user recommendations; and displaying the one or more human-readable user recommendations.

In other implementations, updating the user recommendation includes recalling the user prompt, which can be initiated by an alert trigger function; querying the database; retrieving structural and/or relational latent data from the database based on the user prompt; providing relevant structural and/or relational latent data to the machine learning model, wherein the machine learning model outputs one or more user recommendations related to the user prompt, wherein at least one of the one or more user recommendations is an updated or new user recommendation; and displaying the one or more user recommendations.

In some implementations, the output of the machine learning model is appended to a log of user recommendations in the database. In some implementations, the log of user recommendations is time-stamped. In other implementations, the log of user recommendations includes the user recommendations and all associated metadata.

In some implementations, the alert trigger function may be a timer function or may include a status change alert, wherein a change in status relates to a status change in the database and/or machine learning model retraining. In some implementations, the trigger function includes a threshold variable.

In some implementations, the alert trigger function is configured to operate without user input and configured to initiate push notifications.

In some implementations, the machine learning model includes a neural network, a convolutional neural network, a graph neural network, a random forest (list of compatible MLM). In some implementations, training the machine learning model includes determining a set of parameters and weights of layers, nodes, or trees, as appropriate. In some implementations, the machine learning model is a random forest, and in such a case, the weights of the trees and/or notes are updated in the steps for updating the database.

### CONFIGURATION OF CERTAIN IMPLEMENTATIONS

Machine Learning. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target or target) during training with a labeled data set (or dataset). In an unsupervised learning model, the model a pattern in the data. In a semi-supervised model, the model learns a function that maps an input (also known as feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, an output layer, and optionally one or more hidden layers. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully connected layer includes neurons, where each neuron is connected to all of the neurons in the previous layer. The layers are stacked similar to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

A k-NN classifier is a supervised classification model that classifies new data points based on similarity measures (e.g., distance functions). The k-NN classifiers are trained with a data set (also referred to herein as a “dataset”) to maximize or minimize an objective function, for example, a measure of the k-NN classifier's performance, during training. This disclosure contemplates that any algorithm that finds the maximum or minimum of the objective function can be used. The k-NN classifiers are known in the art and are therefore not described in further detail herein.

Common examples of machine learning optimization operation include AdaBoost, Random forest, XGBoost, Decision tree learning, and the like.

In some implementations, the LLM includes a generic language model, wherein a generic language model is trained on any source of natural language. In other implementations, the LLM includes a language model trained on natural language sources relevant to the user prompt.

A language model is a model that contextualizes language or non-language data into contextualized language data, e.g. text data. The language model can be developed by one, two, or three training evolutions that are progressively more complex. In a first evolution, the language model can identify text data; in a second evolution, the language model can contextualize text data, and in a third evolution, the language model can understand and produce text data with intent. As the size and complexity of the training data increases, the language model grows in complexity and robustness, such language models are termed large language models (LLM). As used herein, a LLM can be any language model that has been trained on sufficiently large amounts of textual data. In some aspects, any available LLM can be used in the disclosed system and method. In exemplary aspects, a LLM trained to understand intent is used.

A cognitive search function can refer to an advanced search capability that goes beyond traditional keyword matching by using artificial intelligence (AI), natural language processing (NLP), and machine learning to understand the context, intent, and semantic meaning of a query.

Example Computing System. The exemplary system and method may be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts, and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

The computer system is capable of executing the software components described herein for the exemplary method or systems. In an embodiment, the computing device may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device to provide the functionality of a number of servers that are not directly bound to the number of computers in the computing device. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or can be hired on an as-needed basis from a third-party provider. Some cloud computing environments may comprise cloud computing resources owned and operated by the enterprise as well as cloud computing resources hired and/or leased from a third-party provider.

In its most basic configuration, a computing device, such as a server, includes at least one processing unit and system memory. Depending on the exact configuration and type of computing device, system memory may be volatile (such as random-access memory (RAM)), non-volatile (such as read-only memory (ROM), flash memory, etc.), or some combination of the two.

The processing unit may be a standard programmable processor that performs arithmetic and logic operations necessary for the operation of the computing device. While only one processing unit is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

Computing devices may have additional features/functionality. For example, the computing device may include additional storage such as removable storage and non-removable storage including, but not limited to, magnetic or optical disks or tapes. Computing devices may also contain network connection(s) that allow the device to communicate with other devices, such as over the communication pathways described herein. The network connection(s) may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing devices may also have input device(s) associated with a User Device (140) such as keyboards, keypads, switches, dials, mice, trackballs, touch screens, voice recognizers, card readers, paper tape readers, or other well-known input devices. Output device(s) may also be associated with the User Device (140) such as printers, video monitors, liquid crystal displays (LCDs), touch screen displays, displays, speakers, etc., may also be included. The additional devices may be connected to the bus in order to facilitate the communication of data among the components of the computing device. All these devices are well known in the art and need not be discussed at length here.

The processing unit may be configured to execute program code encoded in tangible, computer-readable media on the memory. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is not limited to volatile media, non-volatile media, removable media, and non-removable media implemented in any method or technology for storage of information such as computer-readable instructions, data structures, program modules, or other data. System memory, removable storage, and non-removable storage are all examples of tangible computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.

What is claimed is:

1. A computer-implemented method comprising:
populating a database based on a user objective;
receiving a user prompt;
querying the database based on the user prompt;
retrieving structural and relational latent data from the database based on the user prompt, wherein the structural and relational latent data is relevant to the user prompt;
providing relevant structural and relational latent data to a machine learning model, wherein the machine learning model outputs one or more latent user recommendations related to the user prompt;
converting, using a large language model, the one or more latent user recommendations to one or more human-readable user recommendations; and
displaying the one or more human-readable user recommendations.

2. The computer-implemented method of claim 1, wherein populating the database comprises:
performing a search using the user objective;
retrieving relevant data;
labeling, by an expert, the relevant data with structural and relational labels;
providing the labeled relevant data to the machine learning model;
training the machine learning model using the labeled relevant data; and
populating the database with structured data and weights of the machine learning model.

3. The computer-implemented method of claim 1, further comprising updating the database, wherein updating the database comprises:
retrieving, at periodic intervals, relevant data, wherein the periodic intervals are initiated by a timer function;
labeling the unlabeled relevant data using a classifier;
providing the labeled relevant data to the machine learning model;
updating the weights of the machine learning model using the labeled relevant data; and
updating the database with structured data and updated weights of the machine learning model.

4. The computer-implemented method of claim 3, wherein the classifier is one of linear regression, Naïve Bayes', or a k-NN.

5. The computer-implemented method of claim 3, wherein the timer function is a web-based resource, wherein the web-based resource comprises a web-based application, a web-based database server, or combinations thereof.

6. The computer-implemented method of claim 3, wherein updating the database is initiated by a change in status alert, wherein a change in status relates to a status change in the database and/or machine learning model retraining.

7. The computer-implemented method of claim 6, wherein the change in status alert is related to a trigger function that comprises a threshold variable.

8. The computer-implemented method of claim 1, wherein the machine learning model comprises a neural network, a convolutional neural network, a graph neural network, or a random forest.

9. The computer-implemented method of claim 1, wherein the database comprises structural and relational data and MLM weights.

10. The computer-implemented method of claim 1, wherein the one or more human-readable user recommendations comprises one or more of:
one or more relevant facts from the database,
a relational statement from the one or more relevant facts to the user prompt,
a user recommendation for next steps, or
combinations thereof.

11. The computer-implemented method of claim 1, wherein the user objective is associated with a field of business, a market segment, technology commercialization, and/or related commercial entities.

12. The computer-implemented method of claim 1, wherein the user prompt is a text string.

13. The computer-implemented method of claim 1, further comprising: providing the user prompt to a large language model, wherein the large language model outputs a latent user prompt.

14. The computer-implemented method of claim 13, further comprising: using a cognitive search function to deconstruct the latent user prompt into a database query.

15. The computer-implemented method of claim 1, wherein the user prompt is associated with a finite question related to the user objective.

16. A system comprising:
a processor, and a memory storing instructions thereon, wherein execution of the instructions causes the processor to:
populate a database based on a user objective;
receive a user prompt;
query the database based on the user prompt;
retrieve structural and relational latent data from the database based on the user prompt, wherein the structural and relational latent data is relevant to the user prompt;
provide relevant structural and relational latent data to a machine learning model, wherein the machine learning model outputs one or more latent user recommendations related to the user prompt;
convert, using a large language model, the one or more latent recommendations to one or more human-readable user recommendations; and
display the one or more human-readable user recommendations.

17. The system of claim 16, the memory storing further instructions thereon, wherein execution of the instructions causes the processor to populate the database based on a user objective by:
performing a search using the user objective;
retrieving relevant data;
labeling, by an expert, the relevant data with structural and relational labels;
providing the labeled relevant data to the machine learning model;
training the machine learning model using the labeled relevant data; and
populating the database with structured data and weights of the machine learning model.

18. The system of claim 16, the memory storing further instructions thereon, wherein execution of the instructions causes the processor to update the database by:
retrieving, at periodic intervals, relevant data, wherein the periodic intervals are initiated by a timer function;
labeling the unlabeled relevant data using a classifier;
providing the labeled relevant data to the machine learning model;
updating the weights of the machine learning model using the labeled relevant data; and
updating the database with structured data and updated weights of the machine learning model.

19. The system of claim 16, the memory storing further instructions thereon, wherein execution of the instructions causes the processor to further updating the database by:
retrieving, at periodic intervals, relevant data, wherein the periodic intervals are initiated by a timer function;
labeling the unlabeled relevant data using a classifier;
providing the labeled relevant data to the machine learning model;
updating the weights of the machine learning model using the labeled relevant data; and
updating the database with structured data and updated weights of the machine learning model.

20. The system of claim 19, wherein the classifier is one of linear regression, Naïve Bayes', or a k-NN.
